(19) United States
(12) Patent Application Publication
(10) Pub. No.: US 2025/0230896 A1
(43) Pub. Date: Jul. 17, 2025

(54) Cabinet Installation Device

(71) Applicant: Jeremy Sosh, Marion, IN (US)

(72) Inventor: Jeremy Sosh, Marion, IN (US)

(21) Appl. No.: 18/415,129

(22) Filed: Jan. 17, 2024

(51) Int. Cl. F16M 11/22; B25B 11/00

(52) U.S. Cl. CPC F16M 11/22; B25B 11/00

(57) ABSTRACT

A cabinet installation device for holding a cabinet in position above a countertop during installation includes a first panel and a second panel. A plurality of tubes is releasably couplable to the first panel. A plurality of shafts is releasably couplable to the second panel. Each shaft of the plurality of shafts is releasably couplable to an associated tube of the plurality of tubes. A coupler releasably couples each tube of the plurality of tubes to the first panel. The coupler releasably couples each shaft of the plurality of shafts to the second panel. Each shaft of the plurality of shafts is alignable with the associated tube of the plurality of tubes when the plurality of tubes are coupled to the first panel and the plurality of shafts are coupled to the second panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to support structures and more particularly pertains to a new support structure for holding a cabinet in position above a countertop during installation.

### (2) Description of Related Art Including Information Disclosed Under 37 CFR 1.97 and 1.98

The prior art relates to support structures. More particularly, the prior art relates to devices used to support cabinets and other large fixtures during installation. Typically, cabinet installation requires the labor of at least two individuals-one to hold the cabinet and the other to install the screws or other fasteners that affix the cabinet to the wall. The prior art does disclose some devices for assisting a crew in installing cabinets, but such devices are typically large, heavy, and difficult for a single person to use without assistance. Thus, there is a need for a device that can support a cabinet while a single person installs the cabinet. Ideally, the device would be small and portable enough for the single person to use it without assistance, reducing the time and costs associated with cabinet installation.

### BRIEF SUMMARY OF THE INVENTION

An embodiment of the disclosure meets the needs presented above by generally comprising a first panel. A plurality of tubes is releasably couplable to the first panel. A second panel is also included. A plurality of shafts is releasably couplable to the second panel. Each shaft of the plurality of shafts is releasably couplable to an associated tube of the plurality of tubes. A coupler releasably couples each tube of the plurality of tubes to the first panel. The coupler releasably couples each shaft of the plurality of shafts to the second panel. Each shaft of the plurality of shafts is alignable with the associated tube of the plurality of tubes when the plurality of tubes are coupled to the first panel and the plurality of shafts are coupled to the second panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a cabinet installation device according to an embodiment of the disclosure.

FIG. 2 is an exploded view of an embodiment of the disclosure.

FIG. 3 is a detail view of an embodiment of the disclosure.

FIG. 4 is an exploded view of an embodiment of the disclosure.

FIG. 5 is a detail view of an embodiment of the disclosure.

FIG. 6 is an exploded view of an embodiment of the disclosure.

FIG. 7 is a front perspective view of an embodiment of the disclosure.

FIG. 8 is an in-use view of an embodiment of the disclosure.

FIG. 9 is an in-use view of an embodiment of the disclosure.

### DETAILED DESCRIPTION OF THE INVENTION

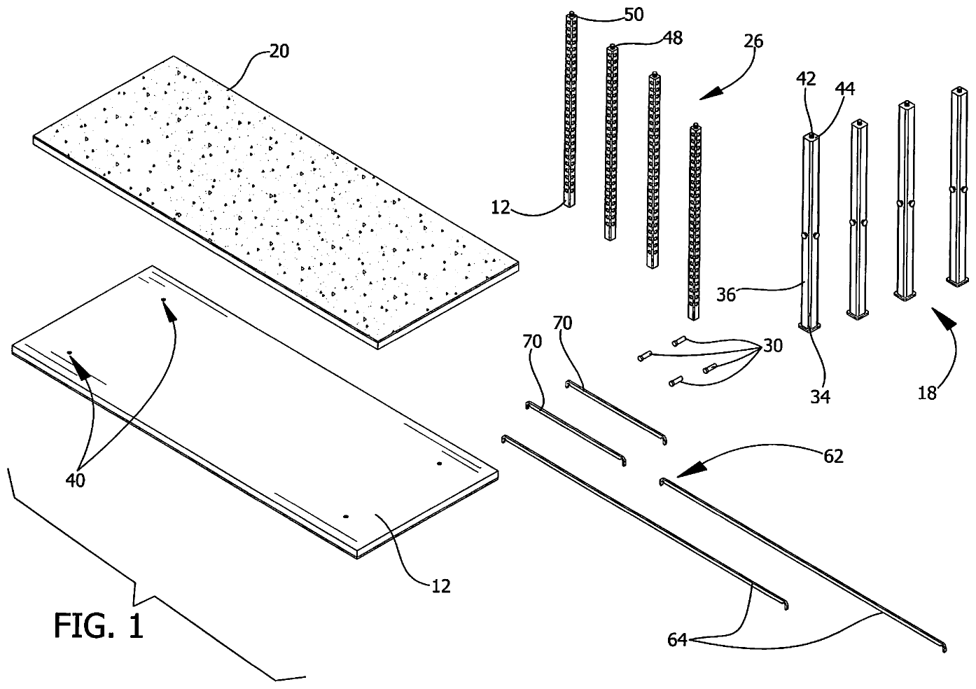

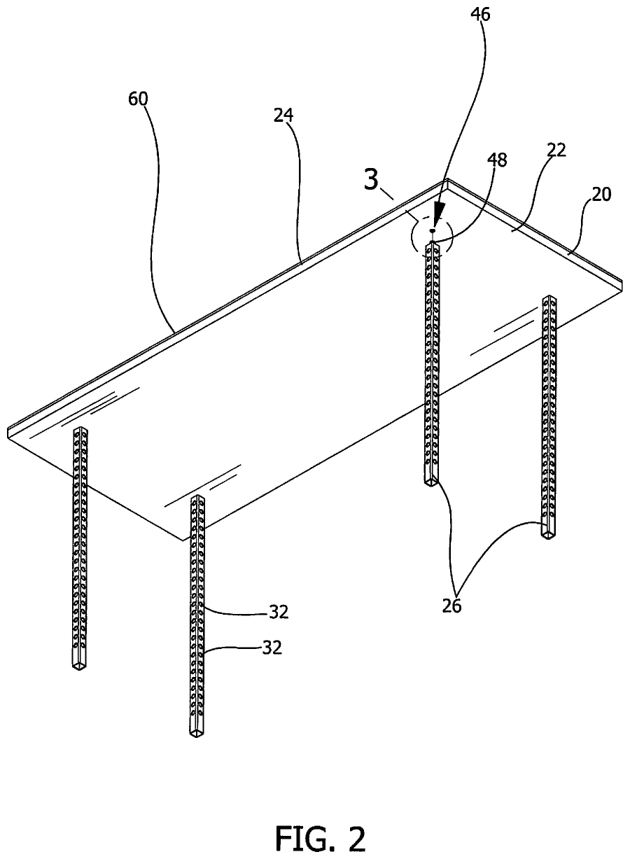

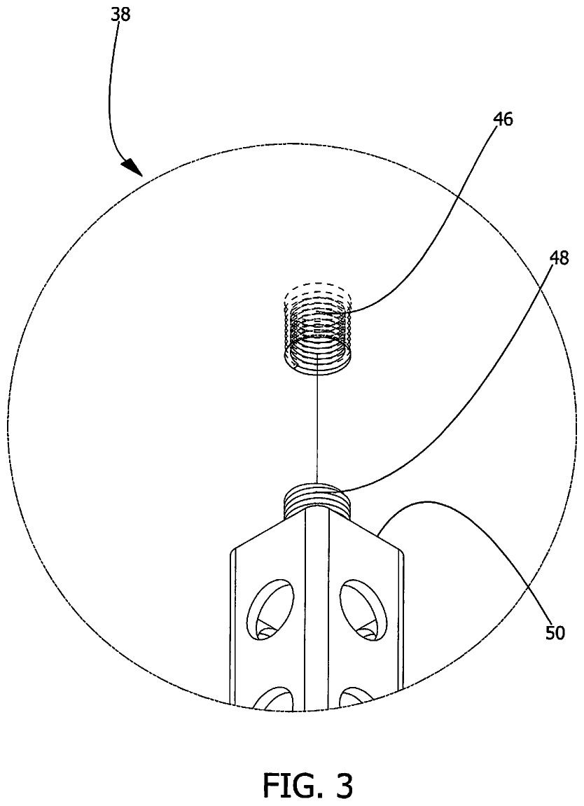

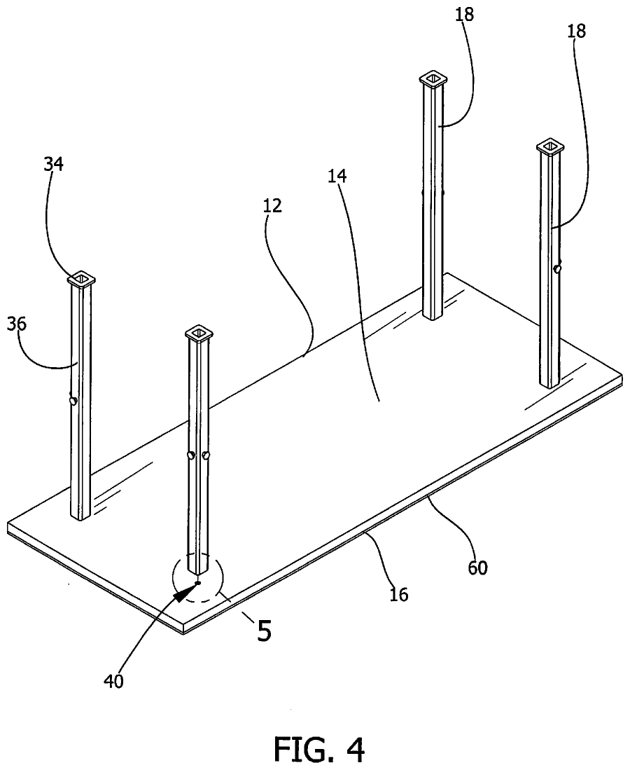

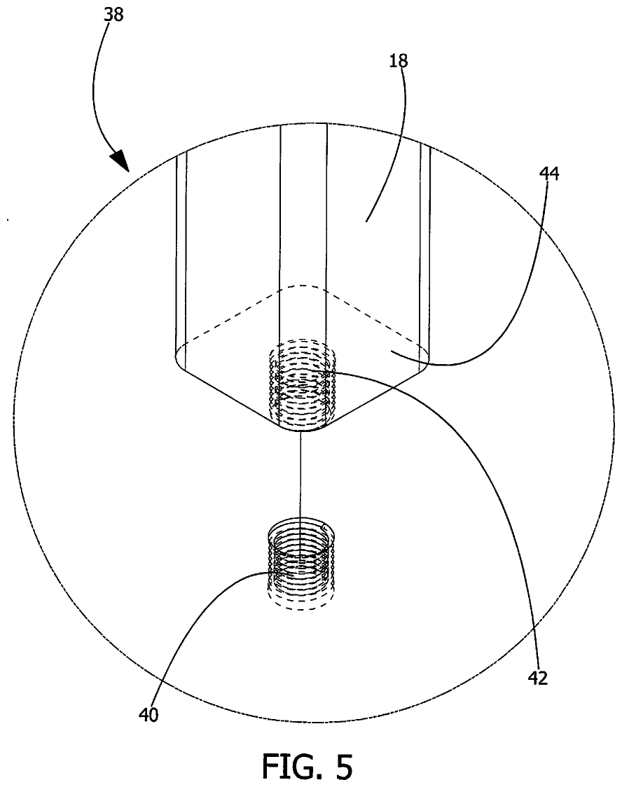

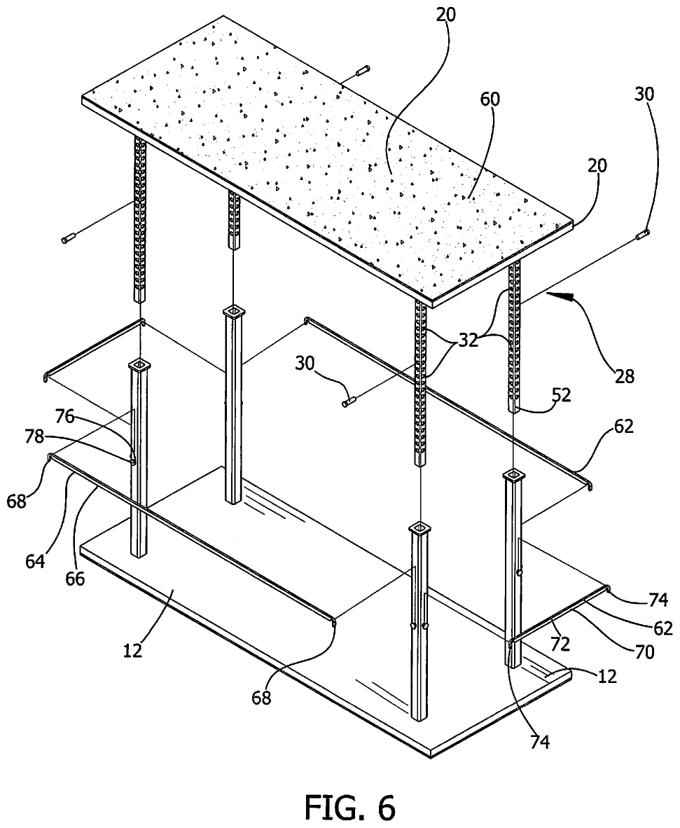

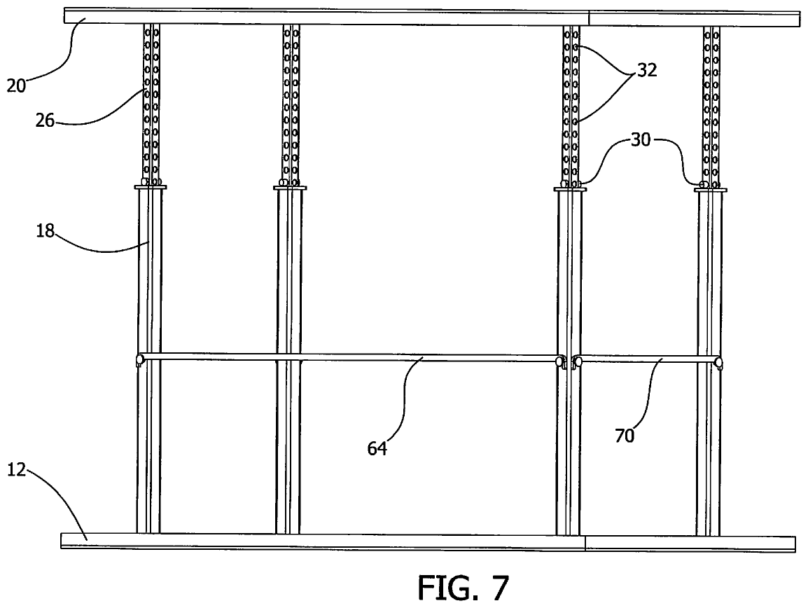

With reference now to the drawings, and in particular to FIGS. 1 through 9 thereof, a new support structure embodying the principles and concepts of an embodiment of the disclosure and generally designated by the reference numeral 10 will be described.

As best illustrated in FIGS. 1 through 9, the cabinet installation device 10 generally comprises a first panel 12 having a first side 14 and a second side 16. One or both of the first side 14 and the second side 16 may be planar. The first panel 12 may have a height between 0.25 inch and 0.75 inch, a length between 25.0 inches and 35.0 inches, and a width between 10.0 inches and 14.0 inches.

A plurality of tubes 18 is being releasably couplable to the first side 14 of the first panel 12.

A second panel 20 has a primary side 22 and a secondary side 24. One or both of the primary side 22 and the secondary side 24 may be planar. The second panel 20 may have a height between 0.25 inch and 0.75 inch, a length between 25.0 inches and 35.0 inches, and a width between 10.0 inches and 14.0 inches.

A plurality of shafts 26 is releasably couplable to the primary side 22 of the second panel 20. Each shaft of the plurality of shafts 26 is releasably couplable to an associated tube of the plurality of tubes 18.

The plurality of tubes 18 may be telescopically couplable to the plurality of shafts 26. Each shaft of the plurality of shafts 26 may be nested within the associated tube of the plurality of tubes 18 such that each shaft of the plurality of shafts 26 is extendable relative to the associated tube of the plurality of tubes 18.

A retainer 28 may be engageable with each shaft of the plurality of shafts 26 to releasably secure each shaft of the plurality of shafts 26 at a selected position relative to the associated tube of the plurality of tubes 18. For example, the retainer 28 may comprise a pin 30 that is positionable within one of a plurality of aligned apertures 32 extending through each shaft of the plurality of shafts 26. The pin 30 may extend outwardly from each shaft of the plurality of shafts 26 when the pin 30 is positioned within the one of the plurality of aligned apertures 32 wherein opposing ends of the pin 30 rest on an upper edge 34 of the associated tube of the plurality of tubes 18 to releasably secure each shaft of the plurality of shafts 26 at the selected position relative to the associated tube of the plurality of tubes 18. The upper edge 34 of each tube of the plurality of tubes 18 may extend outwardly from a body 36 of each tube of the plurality of tubes 18 wherein the upper edge 34 has a width exceeding a width of the body 36.

A coupler 38 may releasably coupling each tube of the plurality of tubes 18 to the first panel 12. The coupler 38 also releasably couples each shaft of the plurality of shafts 26 to the second panel 20 wherein each shaft of the plurality of shafts 26 is alignable with the associated tube of the plurality of tubes 18 when the plurality of tubes 18 are coupled to the first panel 12 and the plurality of shafts 26 are coupled to the second panel 20.

The coupler 38 may further comprise a plurality of holes 40 extending into the first side 14 of the first panel 12. Each hole of the plurality of holes 40 may be positioned proximate to a corner of the first panel 12. Each hole of the plurality of holes 40 may be spaced from a perimeter edge of the first side 14 by between 1.5 inches and 3.5 inches.

A rod 42 may be coupled to and extend upwardly from a lower end 44 of each tube of the plurality of tubes 18. The rod 42 is generally distal to the upper edge 34 of each tube of the plurality of tubes 18. The rod 42 may be parallel to each tube of the plurality of tubes 18. The rod 42 may be centrally positioned on the lower end 44 of each tube of the plurality of tubes 18. The rod 42 generally has a shape that is complementary to a shape of the plurality of holes 40 wherein the rod 42 is positionable within an associated hole of the plurality of holes 40.

Each hole of the plurality of holes 40 may be threaded. The rod 42 on each tube of the plurality of tubes 18 may also be threaded complementary to the plurality of holes 40 wherein each tube of the plurality of tubes 18 is threadably couplable to the associated hole of the plurality of holes 40.

Each tube of the plurality of tubes 18 may be perpendicular to the first panel 12 when each tube of the plurality of tubes 18 is coupled to the first panel 12.

A plurality of bores 46 may extend into the primary side 22 of the second panel 20. Each bore of the plurality of bores 46 may be positioned proximate to a corner of the primary side 2 of the second panel 20. Each bore of the plurality of bores 46 may be spaced from a peripheral edge of the primary side 22 by between 1.5 inches and 3.5 inches. For example, each bore of the plurality of bores 46 may be alignable with each hole of the plurality of holes 40 when the second panel 20 is positioned above the first panel 12.

A post 48 may extend upwardly from a primary end 50 of each shaft of the plurality of shafts 26. The primary end 50 may be positioned outside of the associated tube of the plurality of tubes 18 when each shaft of the plurality of shafts 26 is nested within the associated tube of the plurality of tubes 18. The post 48 may be parallel to each shaft of the plurality of shafts 26. The post 48 may be centrally positioned on the primary end 50 of each shaft of the plurality of shafts 26. The post 48 may have a shape that is complementary to a shape of the plurality of bores 46 wherein the post 48 on each shaft of the plurality of shafts 26 is positionable within an associated bore of the plurality of bores 46.

Each bore of the plurality of bores 46 may be threaded. The post 48 on each shaft of the plurality of shafts 26 may also be threaded complementary to the plurality of bores 46 wherein each shaft of the plurality of shafts 26 is threadably couplable to the associated bore of the plurality of bores 46.

Each shaft of the plurality of shafts 26 may be perpendicular to the second panel 20 when each shaft of the plurality of shafts 26 is coupled to the second panel 20.

A secondary end 52 of each shaft of the plurality of shafts 26 is generally distal to the primary end 50. The secondary end 52 may be positioned within the associated tube of the plurality of tubes 18 when each shaft of the plurality of shafts 26 is nested within the associated tube of the plurality of tubes 18.

The first panel 12 may be configured to be positionable on an external surface 54 and the second panel 20 may be configured to be positionable above the first panel 12. For example, the external surface 54 may include a floor and a countertop. The first panel 12 may be aligned with the second panel 20. The second panel 20 may be configured to support a cabinet 56, or another object or fixture, above the external surface 54 while the cabinet 56 is being coupled to a wall 58 or otherwise installed.

A friction pad 60 may be coupled to each of the first panel 12 and the second panel 20. The friction pad 60 may cover the second side 16 of the first panel 12 and the secondary side 24 of the second panel 20. The friction pad 60 may comprise a textured material that is configured to increase friction between the external surface 54 and the first panel 12. The textured material may be configured to increase friction between the cabinet 56 and the second panel 20.

A plurality of bars 62 may be releasably couplable with the plurality of tubes 18. Each bar of the plurality of bars 62 may extend between a first tube of the plurality of tubes 18 and a second tube of the plurality of tubes 18 wherein the plurality of bars 62 is configured to stabilize a position of the first tube of the plurality of tubes 18 relative to the second tube of the plurality of tubes 18 when each of the first tube of the plurality of tubes 18 and the second tube of the plurality of tubes 18 is coupled to the first panel 12.

The plurality of bars 62 may further comprise a first set of bars 64 that is aligned with a first pair of opposing lateral sides of the first panel 12 when the plurality of tubes 18 are coupled to the first panel 12. The first set of bars 62 may further comprise a strut 66 having a length that is complementary to a length of the first pair of opposing lateral sides. A hook 68 may be coupled to each opposing lateral end of the strut 66. The hook 68 may be angled downwardly relative to the strut 66, for example being perpendicular to the strut 66.

A second set of bars 70 may be aligned with a second pair of opposing lateral sides of the first panel 12 when the plurality of tubes 18 are coupled to the first panel 12. The second set of bars 70 may further comprise a spar 72 having a length that is complementary to a length of the second pair of opposing lateral sides. A finger 74 may be coupled to each opposing lateral end of the spar 72. The finger 74 may be angled downwardly relative to the spar 72, for example being perpendicular to the spar 74.

The first set of bars 64 may have a length exceeding a length of the second set of bars 70, for example because the first pair of opposing lateral sides of the first panel 12 are longer than the second pair of opposing lateral sides of the first panel 12.

A stem 76 may be coupled to each tube of the plurality of tubes 18. The stem 76 may extend outwardly from each tube of the plurality of tubes 18 to releasably engage one of the hook 68 and the finger 74 thereby coupling a bar of the plurality of bars 62 to each tube of the plurality of tubes 18. The stem 76 may be perpendicular to each tube of the plurality of tubes 18. The stem 76 may be centrally positioned along a length of each tube of the plurality of tubes 18.

A stop 78 may be coupled to the stem 76. The stop 78 may be spaced from each tube of the plurality of tubes 18. The stop 78 may extend outwardly from the stem 76 wherein the stop 78 is configured to inhibit the bar of the plurality of bars 62 from falling off of each tube of the plurality of tubes 18.

In use, the first panel 12 and the second panel 20 can be coupled together via the plurality of tubes 18 and the plurality of shafts 26. The distance between the first panel 12 and the second panel 20 may be adjusted by changing the position of each shaft of the plurality of shafts 26 relative to the associated tube of the plurality of tubes 18. The cabinet installation device 10 may be easily transported between job sites, for example by disassembling the cabinet installation device 10.

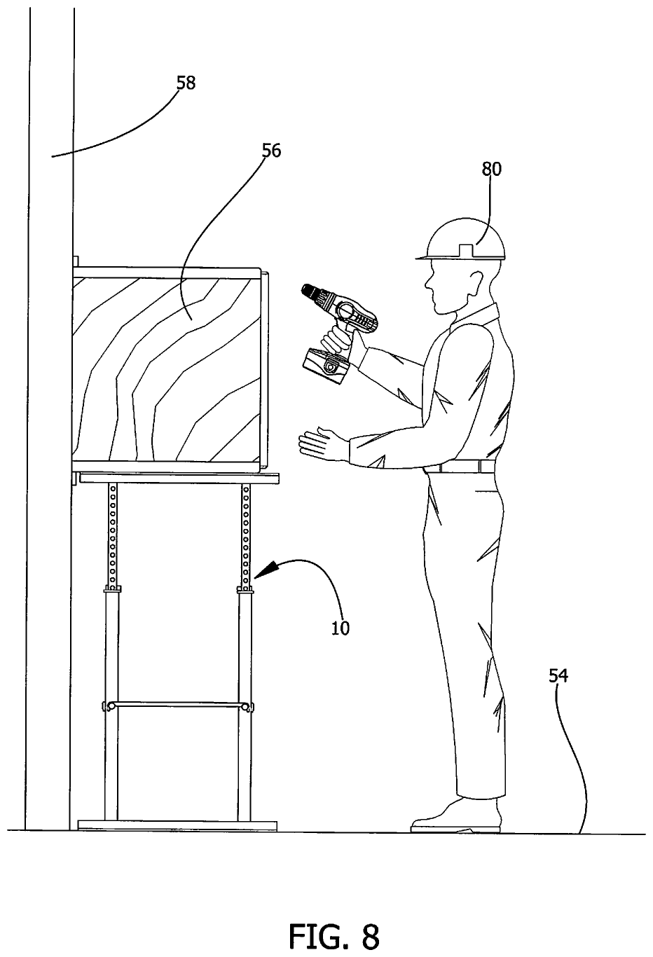

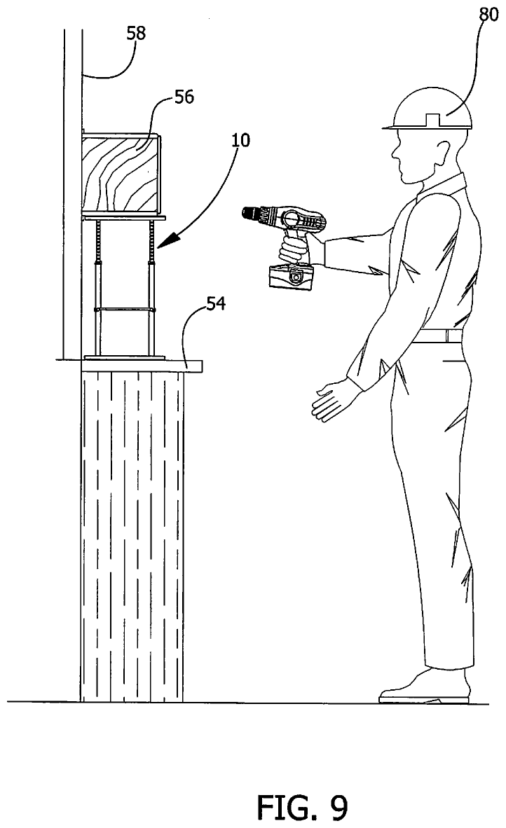

The embodiment shown in FIG. 9 may have a height between 10.0 inches and 30.0 inches. For example, the cabinet installation device 10 may have a minimum height of 13.0 inches. Adjustment of the position of the plurality of shafts 25 relative to the plurality of tubes 18 may increase the cabinet installation device 10 to a maximum height of 26.0 inches. Because of the relatively small size, such embodiments may be easily transported around a job site, or between job sites, without disassembling the cabinet installation device 10. The embodiment shown in FIG. 8 may have a greater height than the embodiment shown in FIG. 9, so that the FIG. 8 embodiment can be positioned on the ground or floor 54 underneath the cabinet 56. Embodiments of the cabinet installation device 10 are generally configured for a single user 80 to install the cabinet 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable stand assembly comprising:
a first panel;
a plurality of tubes being releasably couplable to the first panel;
a second panel;
a plurality of shafts being releasably couplable to the second panel, each shaft of the plurality of shafts being releasably couplable to an associated tube of the plurality of tubes; and
a coupler releasably coupling each tube of the plurality of tubes to the first panel, the coupler releasably coupling each shaft of the plurality of shafts to the second panel wherein each shaft of the plurality of shafts is alignable with the associated tube of the plurality of tubes when the plurality of tubes are coupled to the first panel and the plurality of shafts are coupled to the second panel.

2. The adjustable stand assembly of claim 1, wherein the first panel is configured to be positionable on a countertop and the second panel is configured to be positioned above the first panel, the first panel being aligned with the second panel, the second panel being configured to support a cabinet above the countertop while the cabinet is being coupled to a wall.

3. The adjustable stand assembly of claim 2, further comprising a friction pad being coupled to each of the first panel and the second panel, the friction pad comprising a textured material being configured to increase friction between the countertop and the first panel, the textured material being configured to increase friction between the cabinet and the second panel.

4. The adjustable stand assembly of claim 1, wherein the plurality of tubes is telescopically couplable to the plurality of shafts, each shaft of the plurality of shafts being nested within the associated tube of the plurality of tubes such that each shaft of the plurality of shafts is extendable relative to the associated tube of the plurality of tubes.

5. The adjustable stand assembly of claim 4, further comprising a retainer being engageable with each shaft of the plurality of shafts to releasably secure each shaft of the plurality of shafts at a selected position relative to the associated tube of the plurality of tubes.

6. The adjustable stand assembly of claim 5, the retainer comprising a pin being positionable within one of a plurality of aligned apertures extending through the shaft, the pin extending outwardly from the shaft when the pin is positioned within the one of the plurality of aligned apertures wherein opposing ends of the pin rest on an upper edge of the associated tube to releasably secure the shaft at the selected position relative to the associated tube.

7. The adjustable stand assembly of claim 1, the coupler further comprising:
a plurality of holes extending into a first side of the first panel; and
a rod being coupled to an extending upwardly from a lower end of each tube of the plurality of tubes, the rod having a shape being complementary to a shape of the plurality of holes wherein the rod is positionable within an associated hole of the plurality of holes.

8. The adjustable stand assembly of claim 7, wherein each hole of the plurality of holes is threaded, the rod being threaded complementary to the plurality of holes wherein each tube of the plurality of tubes is threadably couplable to the associated hole of the plurality of holes.

9. The adjustable stand assembly of claim 1, the coupler further comprising:
a plurality of bores extending into a primary side of the second panel; and
a post extending upwardly from a primary end of each shaft of the plurality of shafts, the post having a shape being complementary to a shape of the plurality of bores wherein the post is positionable within an associated bore of the plurality of bores.

10. The adjustable stand assembly of claim 9, wherein each bore of the plurality of bores is threaded, the post being threaded complementary to the plurality of bores wherein each shaft of the plurality of shafts is threadably couplable to the associated bore of the plurality of bores.

11. The adjustable stand assembly of claim 1, wherein each tube of the plurality of tubes is perpendicular to the first panel when each tube of the plurality of tubes is coupled to the first panel.

12. The adjustable stand assembly of claim 1, wherein each shaft of the plurality of shafts is perpendicular to the second panel when each shaft of the plurality of shafts is coupled to the second panel.

13. The adjustable stand assembly of claim 1, further comprising a friction pad being coupled to the first panel, the friction pad comprising a textured material being configured to increase friction on the first panel.

14. The adjustable stand assembly of claim 1, further comprising:
a plurality of bars being releasably couplable with the plurality of tubes, each bar of the plurality of bars extending between a first tube of the plurality of tubes and a second tube of the plurality of tubes wherein the plurality of bars is configured to stabilize a position of the first tube of the plurality of tubes relative to the second tube of the plurality of tubes when each of the first tube of the plurality of tubes and the second tube of the plurality of tubes is coupled to the first panel; and
a stem being coupled to each tube of the plurality of tubes, the stem extending outwardly from each tube of the plurality of tubes to releasably engage a bar of the plurality of bars.

15. The adjustable stand assembly of claim 14, the plurality of bars further comprising:
a first set of bars being aligned with a first pair of opposing lateral sides of the first panel when the plurality of tubes are coupled to the first panel; and
a second set of bars being aligned with a second pair of opposing lateral sides of the first panel when the plurality of tubes are coupled to the first panel.

16. The adjustable stand assembly of claim 15, the first set of bars further comprising:
a strut having a length being complementary to a length of the first pair of opposing lateral sides; and
a hook being coupled to each opposing lateral end of the strut, the hook being angled downwardly relative to the strut.

17. The adjustable stand assembly of claim 15, the second set of bars further comprising:
a spar having a length being complementary to a length of the second pair of opposing lateral sides; and
a finger being coupled to each opposing lateral end of the spar, the finger being angled downwardly relative to the spar.

18. An adjustable stand assembly for supporting a cabinet during installation of the cabinet, the adjustable stand assembly comprising:
a first panel having a first side and a second side, each of the first side and the second side being planar, the first panel having a height between 0.25 inch and 0.75 inch, the first panel having a length between 25.0 inches and 35.0 inches, the first panel having a width between 10.0 inches and 14.0 inches;
a plurality of tubes being releasably couplable to the first side of the first panel;
a second panel having a primary side and a secondary side, each of the primary side and the secondary side being planar, the second panel having a height between 0.25 inch and 0.75 inch, the second panel having a length between 25.0 inches and 35.0 inches, the second panel having a width between 10.0 inches and 14.0 inches;
a plurality of shafts being releasably couplable to the primary side of the second panel, each shaft of the plurality of shafts being releasably couplable to an associated tube of the plurality of tubes;
the plurality of tubes being telescopically couplable to the plurality of shafts, each shaft of the plurality of shafts being nested within the associated tube of the plurality of tubes such that each shaft of the plurality of shafts is extendable relative to the associated tube of the plurality of tubes;
a retainer being engageable with the shaft of the plurality of shafts to releasably secure each shaft of the plurality of shafts at a selected position relative to the associated tube of the plurality of tubes, the retainer comprising:
a pin being positionable within one of a plurality of aligned apertures extending through the shaft, the pin extending outwardly from the shaft when the pin is positioned within the one of the plurality of aligned apertures wherein opposing ends of the pin rest on an upper edge of the associated tube to releasably secure the shaft at the selected position relative to the associated tube;
a coupler releasably coupling each tube of the plurality of tubes to the first panel, the coupler releasably coupling each shaft of the plurality of shafts to the second panel wherein each shaft of the plurality of shafts is alignable with the associated tube of the plurality of tubes when the plurality of tubes are coupled to the first panel and the plurality of shafts are coupled to the second panel, the coupler further comprising:
a plurality of holes extending into the first side of the first panel, each hole of the plurality of holes being positioned proximate to a corner of the first panel, each hole of the plurality of holes being spaced from a perimeter edge of the first side by between 1.5 inches and 3.5 inches;
a rod being coupled to an extending upwardly from a lower end of each tube of the plurality of tubes, the rod being distal to the upper edge of the tube, the rod being parallel to the tube, the rod being centrally positioned on the lower end of the tube, the rod having a shape being complementary to a shape of the plurality of holes wherein the rod is positionable within an associated hole of the plurality of holes;
wherein each hole of the plurality of holes is threaded, the rod being threaded complementary to the plurality of holes wherein each tube of the plurality of tubes is threadably couplable to the associated hole of the plurality of holes;
wherein each tube of the plurality of tubes is perpendicular to the first panel when each tube of the plurality of tubes is coupled to the first panel;
a plurality of bores extending into the primary side of the second panel, each bore of the plurality of bores being positioned proximate to a corner of the primary side of the second panel, each bore of the plurality of bores being spaced from a peripheral edge of the primary side by between 1.5 inches and 3.5 inches;
a post extending upwardly from a primary end of each shaft of the plurality of shafts, the primary end being positioned outside of the associated tube of the plurality of tubes when the shaft of the plurality of shafts is nested within the associated tube of the plurality of tubes, the post being parallel to the shaft, the post being centrally positioned on the primary end of the shaft, the post having a shape being complementary to a shape of the plurality of bores wherein the post is positionable within an associated bore of the plurality of bores;
wherein each bore of the plurality of bores is threaded, the post being threaded complementary to the plurality of bores wherein each shaft of the plurality of shafts is threadably couplable to the associated bore of the plurality of bores;
wherein each shaft of the plurality of shafts is perpendicular to the second panel when each shaft of the plurality of shafts is coupled to the second panel;
wherein a secondary end of each shaft of the plurality of shafts is distal to the primary end, the secondary end being positioned within the associated tube of the plurality of tubes when the shaft is nested within the associated tube of the plurality of tubes;
wherein the first panel is configured to be positionable on an external surface and the second panel is configured to be positioned above the first panel, the external surface including a floor and a countertop, the first panel being aligned with the second panel, the second panel being configured to support a cabinet above the external surface while the cabinet is being coupled to a wall;
a friction pad being coupled to each of the first panel and the second panel, the friction pad covering the second side of the first panel and the secondary side of the second panel, the friction pad comprising a textured material being configured to increase friction between the external surface and the first panel, the textured material being configured to increase friction between the cabinet and the second panel;
a plurality of bars being releasably couplable with the plurality of tubes, each bar of the plurality of bars extending between a first tube of the plurality of tubes and a second tube of the plurality of tubes wherein the plurality of bars is configured to stabilize a position of the first tube of the plurality of tubes relative to the second tube of the plurality of tubes when each of the first tube of the plurality of tubes and the second tube of the plurality of tubes is coupled to the first panel, the plurality of bars further comprising:
a first set of bars being aligned with a first pair of opposing lateral sides of the first panel when the plurality of tubes are coupled to the first panel, the first set of bars further comprising:
a strut having a length being complementary to a length of the first pair of opposing lateral sides;
a hook being coupled to each opposing lateral end of the strut, the hook being angled downwardly relative to the strut;
a second set of bars being aligned with a second pair of opposing lateral sides of the first panel when the plurality of tubes are coupled to the first panel, the second set of bars further comprising:
a spar having a length being complementary to a length of the second pair of opposing lateral sides;
a finger being coupled to each opposing lateral end of the spar, the finger being angled downwardly relative to the spar;
wherein the first set of bars have a length exceeding a length of the second set of bars; and
a stem being coupled to each tube of the plurality of tubes, the stem extending outwardly from each tube of the plurality of tubes to releasably engage one of the hook and the finger thereby coupling a bar of the plurality of bars to each tube of the plurality of tubes, the stem being perpendicular to each tube of the plurality of tubes, the stem being centrally positioned along a length of each tube of the plurality of tubes.
